(19) United States
(12) Patent Application Publication
(10) Pub. No.: US 2012/0166319 A1
(43) Pub. Date: Jun. 28, 2012

(54) METHOD AND SYSTEM FOR LANGUAGE-INDEPENDENT SEARCH WITHIN SCANNED DOCUMENTS

(76) Inventors: Giovanni Deledda, Walldorf (DE); Hermann Resch, Heidelberg (DE); Tanja Soehngen, Neulussheim (DE); Elena Gurevitch, Bad Schonborn (DE); Pascal Hochwarth, Muhlhausen (DE); Benjamin Klehr, Kuppenheim (DE); Hua Wang, Ostringen (DE); Paola Sala, Heidelberg (DE)

(21) Appl. No.: 12/979,878

(22) Filed: Dec. 28, 2010

(51) Int. Cl. G06Q 10/00

(52) U.S. Cl. 705/30

(57) ABSTRACT

In some aspects, a system and method include receipt of a text file representation of an invoice associated with a supplier, receipt, from a database, of an invoice term associated with the supplier, determination, by a processor, of whether the invoice term is in the text file representation of the invoice. If is determined that the invoice term is in the text file representation of the invoice, an anchor term associated with the invoice term is determined. The invoice term and the anchor term are stored in a record associated with the supplier.

### FIELD

Some embodiments relate to searches. More specifically, some embodiments provide a mechanism to conduct a language independent search within scanned documents based on an invoice format of a supplier.

### BACKGROUND

While some of the data items in an invoice may be common to many invoices, there may not be a set, fixed, or shared standard for configuring the data in invoices by companies and organizations. As such, a major concern with processing invoices includes accurately recognizing and determining the relevant data items in an invoice. A number of systems, devices, and processes attempt to disambiguate invoice data by trying to recognize the language of the invoice and, through various methods and processes, interpret what the language means. Such systems and processes may tend to be resource hungry, complex, and not reliably accurate. Some such systems include review and verification operations by a human in an effort to increase the accuracy in recognizing and interpreting the language of the invoices since automated language recognition systems are not typically very accurate. However, such human interaction is also resource intensive and costly. Since there is not set standard configuration for organizing, configuring, or even naming data items on invoices, considerable effort, resources, and techniques have been developed in an attempt to better recognize the language components of invoices given the unstructured nature of invoices.

Accordingly, a language independent method and system for efficiently searching invoices are provided by some embodiments herein.

### BRIEF DESCRIPTION OF THE DRAWINGS

FIG. 1 is a sample invoice, in accordance with some embodiments herein;

FIG. 2 is a flow diagram of a process according to some embodiments;

FIG. 3 is a flow diagram of another process according to some embodiments;

FIG. 4 is a flow diagram of a process according to some embodiments;

FIG. 5 is a flow diagram of yet another process according to some embodiments;

FIG. 6 is a flow diagram of a process according to some embodiments;

FIG. 7 is a flow diagram of a process according to some embodiments;

FIG. 8 is block diagram of a system according to some embodiments; and

FIG. 9 is a block diagram of a system according to some embodiments.

### DETAILED DESCRIPTION

A computer system, device, application, or service may be used to generate a query statement or function, execute the query statement against a collection of data, and display the result of executing the query statement or function. In some instances, the query may relate to an invoice. More generally, the methods and systems herein may relate to, interface with, include, and comprise an invoicing system, application, service, or platform.

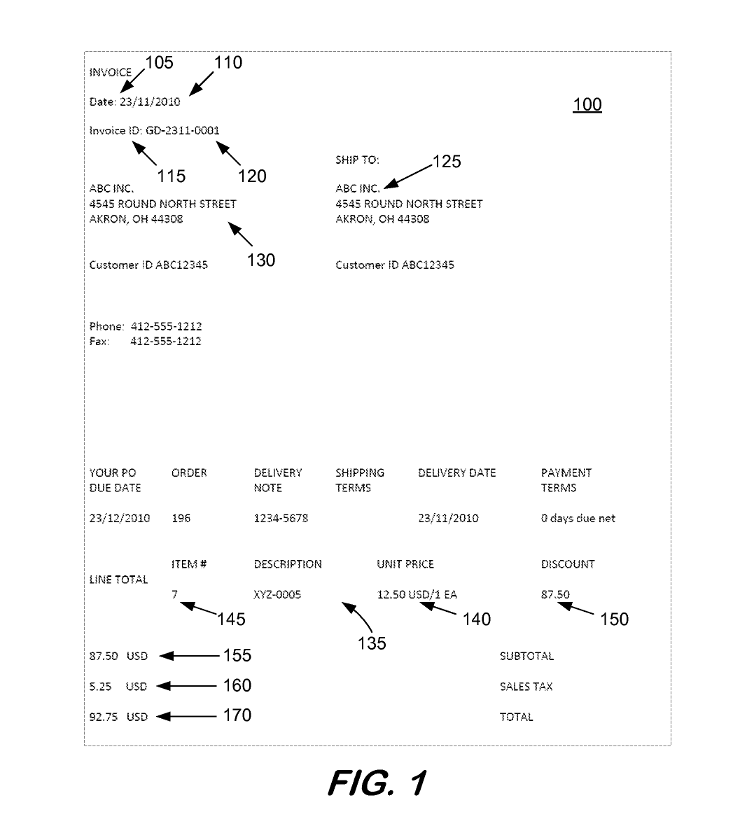

FIG. 1 is an illustrative example of a text file representation 100 of a sample invoice. Invoice 100 may be introduced into a computing system and device by being scanned into the system. In some embodiments, the scanning of a physical invoice may automatically produce an electronic image file of the physical invoice, as well as an electronic text file. Invoice 100 is sample text file, presented for viewing by a user.

As shown, invoice 100 includes a variety and multitude of information thereon. Some of the information included in invoice 100 may be unique to the invoice, and some other information in invoice 100 may include data items that may be typically included in an invoice. For example, invoice 100 includes an invoice date comprising a descriptor or anchor 105 and an invoice term 110. As used herein, the term anchor may refer to a descriptor or label associated with an invoice term (e.g., 110). Additionally, the phrase invoice term refers to a value of an invoice data item. As illustrated in FIG. 1, anchor 105 is a descriptor (e.g., “Date”) associated with the invoice term 110. Invoice term 110 is associated with anchor item 105 and has, a value of “23/11/2010”, which is the date the invoice was issued.

Some of the other types and variety of data items on invoice 100 may include the anchor of “Invoice ID” 115 and an associated invoice term value of “GD-2311-0001” at 120; the invoice term of a supplier name at 125; and the invoice term of an address for the supplier at 130; and a line item 135 including details of invoiced goods and services such as, for example, a cost of an item at 140 (12.50 USD), a quantity of the item delivered at 145 (7), and a total costs based on the cost and quantity of the item at 150. The collective of the total costs based on the cost and quantity of the item forms part of a line item detail at 135. As shown, the line item details reside on one line of invoice 100, although line items details may, in some embodiments, extend beyond a single line of a helpful shower.

In some embodiments, some of the data items on invoice 100 may be commonly found on invoices since the information may typically be needed, used, or desired for the processing and settling of the invoice. Data items such as, for example, an invoice date, the invoice ID, the name and address of the supplier, and line item details may be the type of invoice data items that a business, organization, or user may want to have for each and every invoice they process or intake. In some embodiments herein, the identification and use of anchors on a per supplier basis operates to provide a reliable and efficient mechanism for searching invoices that is language independent. That is, some embodiments herein use anchors specific to each supplier and their invoice configuration, thereby eliminating a need to recognize and understand the language of the invoice since the anchors can be used retrieve relevant invoice data.

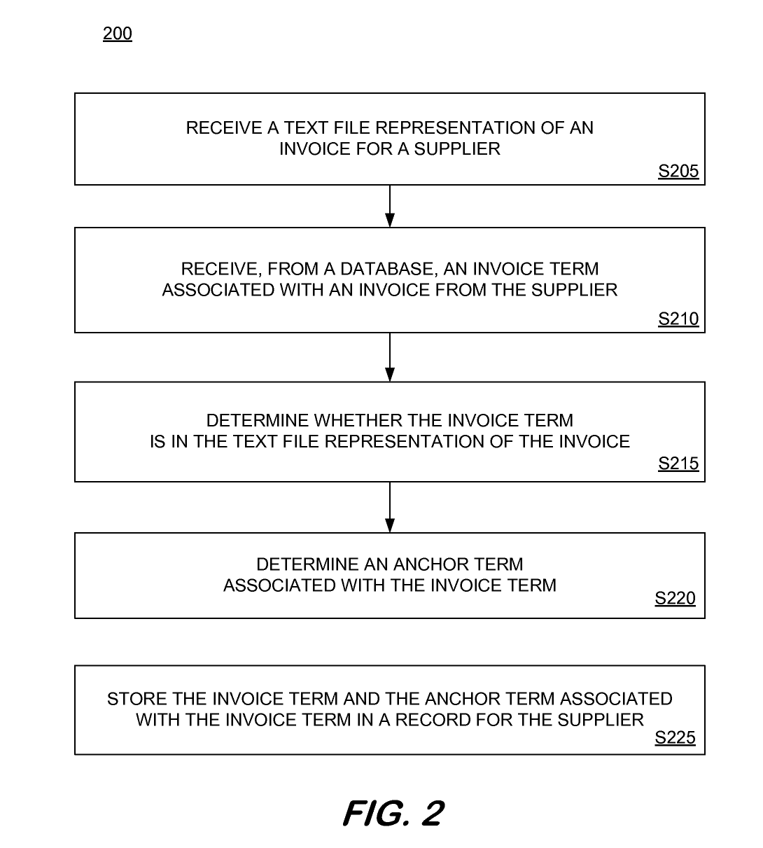

FIG. 2 is a flow diagram of a process 200, in accordance with some embodiments herein. In particular, process 200 conveys a framework for language independent searches of invoices. At S205, a text file representation of an invoice is received. The text file may have been rendered by scanning a physical copy of the invoice received from and issued by the supplier. The scanning operation may occur at some point before S205 or as part of S205. Additionally, an automated system, a human, and combinations thereof may verify an accuracy of the scanning of the invoice as part of or before S205. The text file may be stored in a database or other storage facility. In some embodiments, the text file captures all of the data present in the original invoice.

At S210, an invoice term associated with an invoice from the particular supplier associated with the invoice (i.e., the supplier that generated the invoice) is received. This invoice term may be received from a database. Moreover, the invoice term may have been established for the particular supplier of the invoice during the scanning and verification of the invoice at or before S205. Additionally, the invoice term for and associated with the supplier of the invoice may have been established at some other point prior to S210. As an example, the value “GD-2311-0001” may be received as the invoice term.

At S215, a comparison of the invoice term received from the database and the text file of the invoice being currently processed is invoked. A determination is made whether the invoice term is in the text file representation of the invoice. This comparison and determination is made in an effort to exactly determine the anchor for this invoice term (e.g., “GD-2311-0001”) for the supplier associated with the invoice.

Process 200 proceeds to determine at S220, in an instance it is determined the invoice term is in the text file representation of the invoice, an anchor term associated with the invoice term. This determination is accomplished by an examination of the text file representation of the invoice in a proximity of the searched invoice term. The terms and phrases, if any, in the vicinity of the searched invoice term are examined to determine the proper anchor for the invoice term for the particular supplier. For example, referring to FIG. 1 it is noticed that the words “Invoice ID” are in the immediate vicinity of the invoice term “GD-2311-0001”. Accordingly, it is logically determined that the phrase “Invoice ID” is the anchor for the invoice term “GD-2311-0001” for the supplier of the invoice being processed.

At S220, the determined anchor may be mapped to reference the invoice term. In some embodiments, the spatial relationship between the invoice term (e.g., “GD-2311-0001”) and anchor (e.g., “Invoice ID) is noted and stored at S225 for future reference. The spatial relationship between the invoice term and the anchor may indicate that the anchor for the invoice term is located to the right or left of the invoice term, below the invoice term, above the invoice term, or some other relative position. The invoice term and the anchor term associated with the invoice term are stored in a record for the supplier

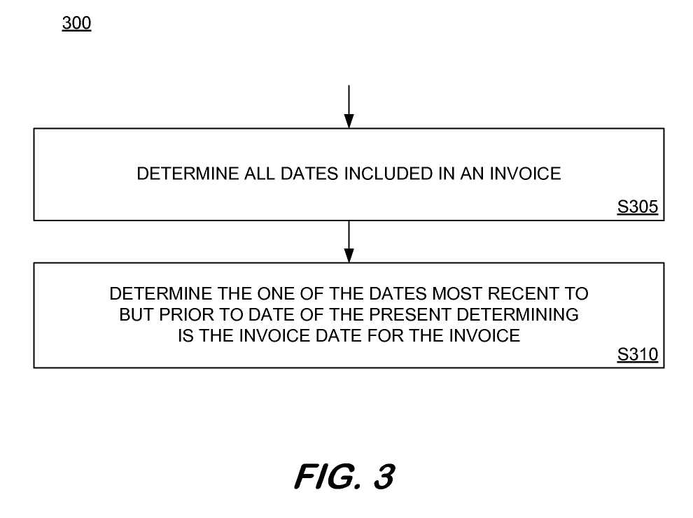

FIG. 3 is an illustrative example of a process 300 that depicts a method according to some embodiments herein. FIG. 3 relates to a process of conducting a search of a scanned invoice from a supplier, where the search is conducted based on and using anchor terms, in accordance with some embodiments herein. In particular, process 300 is directed to a search of an invoice date on a scanned invoice. It is noted that, in some embodiments, the invoice date of a scanned invoice may very well be determined as outlined above in the discussion of FIG. 2, where anchors may be established, determined, and enhanced therein (e.g., “Date” anchor 105) to determine an invoice date of subsequently searched invoices. The process of FIG. 3 provides a mechanism for determining an invoice date that may be used in addition to or as an alternative the certain aspects of FIG. 2.

According to some embodiments, an invoice date for a scanned invoice may be determined by process 300. At S305, all of the dates in an invoice are determined. The invoice may be searched for anchors having the form of a date. For example, the anchors in this example may include various combinations of numerals and words, including abbreviations, that have been established as anchors for dates. Upwards of thirty (30) different date formats and configurations may be considered by an equal number of “invoice date” anchors. For example, the invoice may be searched for dates formatted as DD.MM.YYY, MM.DD.YYYY; MM.DD.YY, DD.MM.YY, and other formats. Upon the discovery of any “invoice date” anchors, the dates associated with each anchor is noted. The dates may be stored (at least temporarily).

At S310, a determination is made regarding which one of the dates resulting from operation S305 is most recent to but prior to the present processing of the invoice. This determined date is logically considered the invoice date, that is the date the invoice for the delivered goods and services was issued.

In some aspects and embodiments, dates other than an invoice date may be determined in accordance with the steps and operations of process 300.

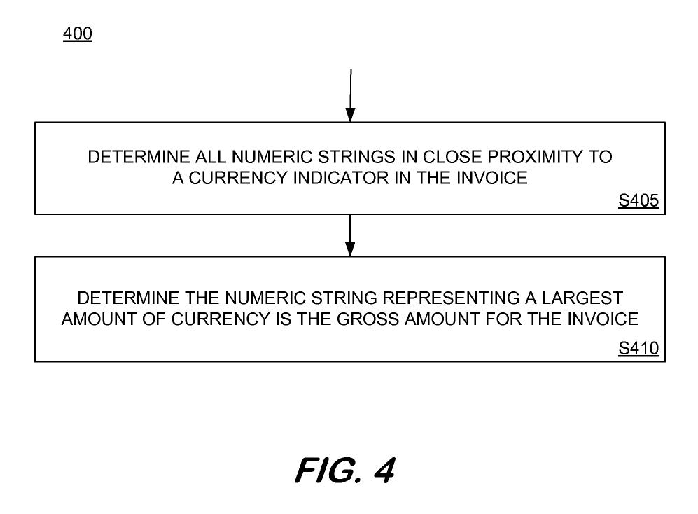

FIG. 4 is an illustrative flow of a process 400 that depicts a method according to some embodiments herein. FIG. 4 relates to a process of conducting a search of a scanned invoice from a supplier, where the search is conducted based on and using anchor terms, in accordance with some embodiments herein. In particular, process 400 is directed to a search of a gross amount of a scanned invoice. In some aspects, the gross amount of an invoice may be the total amount of the invoice without accounting for taxes and other costs. The process of FIG. 4 provides a mechanism for determining a gross amount of an invoice that may be used in addition to or as an alternative the certain aspects of FIG. 2.

At S405, all numeric strings in an invoice are determined. As a part of S405 or prior to S405, the invoice may be searched for the type of currency associated therewith. Anchors representative of the previously found currency type may be used in searching for numeric strings in close proximity with the anchors. The close proximity between the anchors and the numeric strings may indicate the numeric strings are associated with the anchors. Upon the discovery of currency anchors, the currency amounts associated with each anchor are noted. The currency amounts may be stored (at least temporarily).

In some embodiments, a currency amount may be found by determining all numeric values in a scanned invoice document having a decimal separator such as a comma and a period or dot. In some embodiments, it does not matter whether a comma or a dot is used as the decimal separator. For example, each of the following numeric strings would be recognized as a currency amount: 100.16; 100.16; 100,254.76 or 100,254.76.

At S410, a determination is made regarding which one of the currency amounts resulting from operation S405 is the largest. This largest determined currency amount (e.g., FIG. 1, amount 170) is logically considered the gross amount.

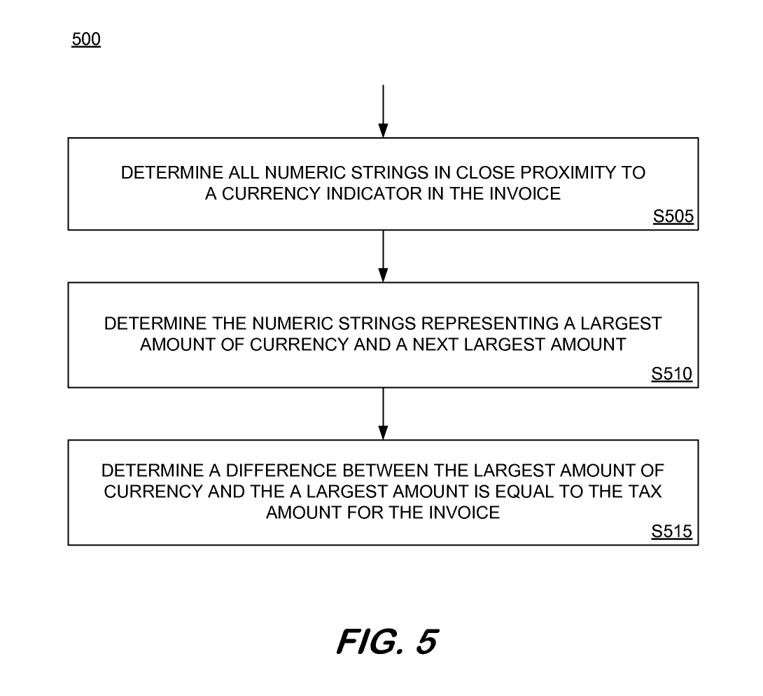

FIG. 5 is an illustrative flow of a process 500 that depicts a method according to some embodiments herein. FIG. 5 relates to a process of conducting a search of a scanned invoice from a supplier, where the search is conducted based on and using anchor terms. In particular, process 500 is directed to a search of a tax amount of a scanned invoice. In some aspects, the tax amount of an invoice may be the total tax paid or due on the invoice. Process 500 provides a mechanism for determining a tax amount of an invoice that may be used in addition to or as an alternative the certain aspects of FIG. 2.

At S505, all numeric strings in an invoice are determined. The invoice may be searched for anchors having the form of a currency. As a part of S505 or prior to S505, the invoice may be searched for the type of currency associated therewith. Anchors representative of the previously found currency type may be used in searching for numeric strings in close proximity with the anchors. The close proximity between the anchors and the numeric strings may indicate the numeric strings are associated with the anchors. Upon the discovery of currency anchors, the currency amounts associated with each anchor is noted. The currency amounts may be stored (at least temporarily).

At S510, a determination is made regarding which one of the currency amounts resulting from operation S505 is the largest amount and which is the next largest amount. The determination of process 510 may include a sorting of the results of operation 505.

At 515, a difference between the largest determined currency amount (e.g., FIG. 1, amount 170) and the next the largest determined currency amount (e.g., FIG. 1, amount 155) is determined. Moreover, the difference between the largest determined currency amount and the next the largest determined currency amount is logically considered the tax amount.

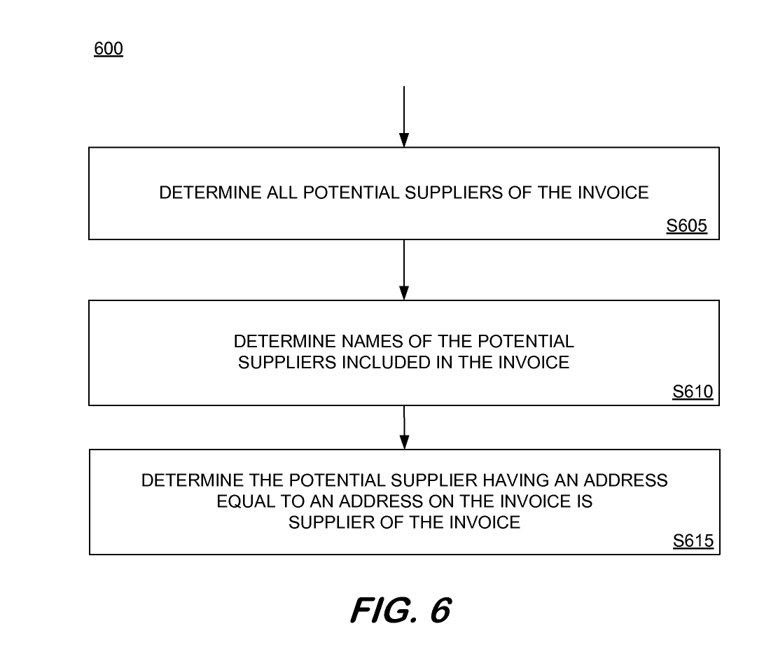

FIG. 6 is an illustrative flow of a process 600, depicting a method according to some embodiments herein. FIG. 6 relates to a process of conducting a search of a scanned invoice from a supplier, where the search is conducted based on and using anchor terms. Process 600 is directed to a search of a supplier of a scanned invoice. Process 600 provides a mechanism for determining a supplier of an invoice that may be used in addition to or as an alternative the certain aspects of FIG. 2.

At S605, all available or potential suppliers are determined from a master list, listing, or record that includes all of the potential suppliers for a user (e.g., a business organization). At S610, the invoice is searched for name matches (e.g., FIG. 1, name 125) with any of the potential suppliers obtained at S605. Continuing with process 600, matches resulting from the determination of S610 are further compared to the invoice based on the address of the potential suppliers and the address(es) on the invoice at S615. Match results including both name and address (e.g., FIG. 1, amount 130) matches of S610 and S615 are logically considered to be the supplier of the invoice. In this manner, the known suppliers as retrieved from a database are compared with the scanned invoice. Accordingly, process 600 is an example of an effective and efficient language independent search of scanned invoices.

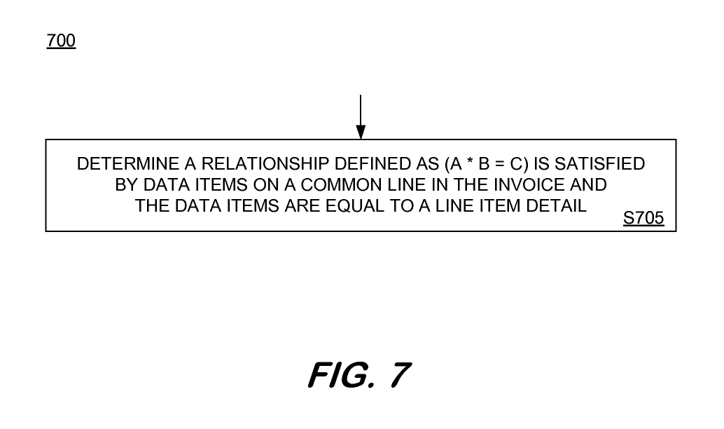

Turning to FIG. 7, a process 700 for searching a scanned invoice for line item details is provided. It is noted that traditionally, the determination of line item details is not an easy task. The difficulty lies, at least in part, with the unstructured nature of the data items included in line items of an invoice. However, the use of language independent anchors herein, eliminates a language dependency.

At S705, a scanned invoice is searched (i.e., queried) for a relationship between terms that may be defined as (a*b=c). In some embodiments, all of the terms a, b, and c, are located on the same line of the scanned invoice. In the event a search of the scanned invoice reveals a group of invoice terms satisfying the (a*b=c) constraint, then the line of the invoice containing the terms is logically considered a “line item”. Invoice 100 may be used as an example of an invoice including a line item. Referring to FIG. 1, it is noted that line item 135 includes quantity term equal to 7 (e.g., “a”), a unit price equal 12.50 USD (e.g., “b”), and a total amount of 87.50 USD (e.g., “c”), where 7*$12.50=$87.50.

In some embodiments, the results of S705 may be verified by comparing the results with a purchase order (p.o.) corresponding to the scanned invoice. In some embodiments, the p.o. corresponding to an invoice is listed or otherwise included in the invoice. The comparison of the determined line item details with the known line item details of the p.o. may operate to verify an accuracy of operation S705.

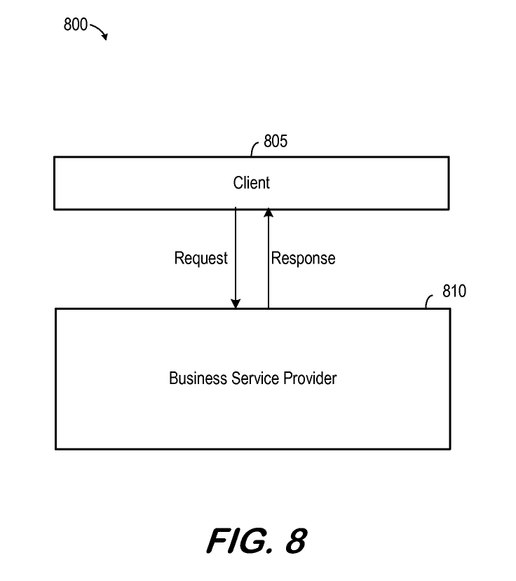

FIG. 8 is a block diagram of a system 800 according to some embodiments. In this case, a business service provider 810 might host and provide business services for a client 805. For example, business service provider 810 may receive requests from the client 405 and provide responses to the client 805 via a service-oriented architecture such as those provided by SAP Business ByDesign®. Note that the business service provider 810 might represent any backend system, including backend systems that belong to the client 805, those that belong to (or are administered by) service providers, those that are web services, etc.

Client 805 may be associated with a Web browser to access services provided by business process platform 810 via HyperText Transport Protocol (HTTP) communication. For example, a user may manipulate a user interface of client 805 to select data items that indicate an instruction. Client 805, in response, may transmit a corresponding HTTP service request to the business service provider 810 as illustrated. A service-oriented architecture may conduct any processing required by the request (e.g., generating queries and executing the queries against a collection of data) and, after completing the processing, provides a response (e.g., search results) to client 805. Client 805 may comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a dedicated standalone application.

In some aspects, FIG. 8 represents a logical architecture for describing processes according to some embodiments, and actual implementations may include more or different elements arranged in other manners. Moreover, each system described herein may be implemented by any number of devices in communication via any number of other public and/or private networks. Two or more of the devices herein may be co-located, may be a single device, or may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Client 805 may provide a user interface for presenting collections of data, such as search results, to a user and receive an indication of a selection of one or more of the data items presented in the user interface. In some embodiments, the data may be associated with data structures hosted by business service provider 810.

Accordingly, a method and mechanism for efficiently and automatically creating and executing a query or search of a scanned invoice from a supplier, where the search is conducted based on and using anchor terms, are provided by some embodiments herein.

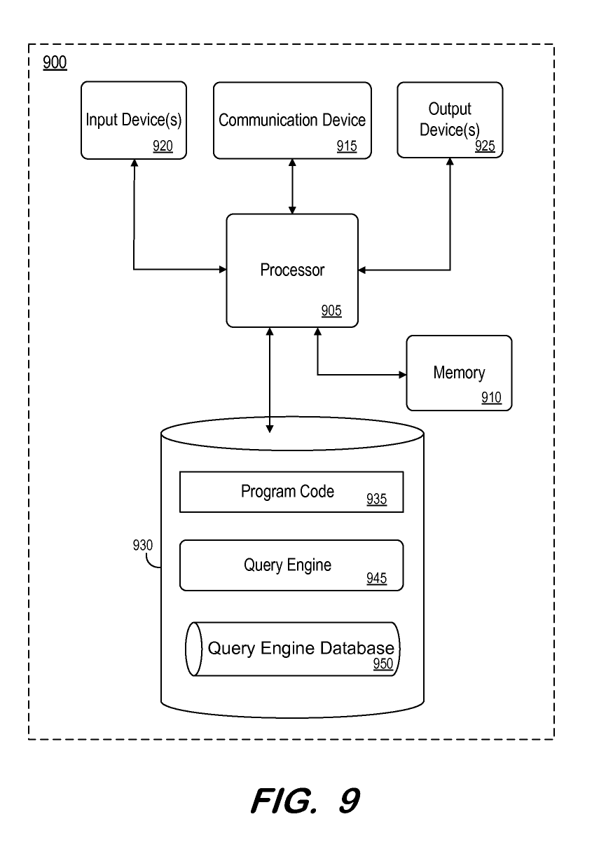

FIG. 9 is a block diagram overview of a search platform 900 according to some embodiments. The search platform 900 may be, for example, associated with any of the devices described herein. The search platform 900 comprises a processor 905, such as one or more commercially available Central Processing Units (CPUs) in the form of one-chip microprocessors or a multi-core processor, coupled to a communication device 915 configured to communicate via a communication network (not shown in FIG. 9) to a front end client (not shown in FIG. 9). Device 900 may also include a local memory 910, such as RAM memory modules. Communication device 915 may be used to communicate, for example, with one or more client devices or business service providers. The search platform engine 900 further includes an input device 920 (e.g., a mouse and/or keyboard to enter content) and an output device 925 (e.g., a computer monitor to display a user interface element).

Processor 905 communicates with a storage device 930. Storage device 930 may comprise any appropriate information storage device, including combinations of magnetic storage devices (e.g., a hard disk drive), optical storage devices, and/or semiconductor memory devices.

Storage device 930 stores a program 935 for controlling the processor 905 and query engine application 945 for determining, constructing, and executing queries. Processor 905 performs instructions of the programs 935 and 945 and thereby operates in accordance with any of the embodiments described herein. Programs 935 and 945 may be stored in a compressed, uncompiled and/or encrypted format. Programs 935 and 945 may furthermore include other program elements, such as an operating system, a database management system, and/or device drivers used by the processor 905 to interface with peripheral devices.

In some embodiments (such as shown in FIG. 9), the storage device 930 stores a query engine database 950 to facilitate the determination and construction of queries. The query database may include data structures, rules, and conditions for determining a query based on user interface selections as described herein.

Although embodiments have been described with respect to web browser displays, note that embodiments may be associated with other types of user interface displays. For example, a user interface may be associated with a portable device such as a smart phone or a tablet computing device, with a user interface element.

Embodiments have been described herein solely for the purpose of illustration. Persons skilled in the art will recognize from this description that embodiments are not limited to those described, but may be practiced with modifications and alterations limited only by the spirit and scope of the appended claims.

1. A computer-implemented method, comprising:
receiving a text file representation of an invoice associated with a supplier;
receiving, from a database, an invoice term associated with the supplier;
determining, by a processor, whether the invoice term is in the text file representation of the invoice;
determining by the processor, in an instance it is determined that the invoice term is in the text file representation of the invoice, an anchor term associated with the invoice term for the supplier associated with the invoice; and
storing the invoice term and the determined anchor term in a record associated with the supplier.

2. The method of claim 1, wherein the determination of whether the invoice term is in the text file representation of the invoice includes comparing the invoice term with the text file.

3. The method of claim 1, wherein the invoice term received from the database is verified as being associated with the supplier before it is stored in the database.

4. The method of claim 1, wherein the text file representation of the invoice is produced by scanning the invoice.

5. The method of claim 1, further comprising:
determining a spatial location of the determined anchor term relative to the associated invoice term; and
storing the spatial location of the determined anchor term in the record.

6. The method of claim 1, further comprising:
conducting a search of a first scanned invoice from the supplier, where the search is based on the determined anchor term.

7. The method of claim 6, wherein the determined anchor term is at least one of: an invoice date, a gross amount, a tax amount, a supplier, and a line item detail.

8. The method of claim 7, wherein the determined anchor term is the invoice date and the conducting of the search of the first scanned invoice comprises:
determining a plurality of dates included in the first scanned invoice;
determining a latest one of the plurality of dates which is prior to a current date; and
determining that the latest one of the plurality of dates is an invoice date of the first scanned invoice.

9. The method of claim 7, wherein the determined anchor term is the gross amount and the conducting of the search of the first scanned invoice comprises:
determining a plurality of numeric strings in close proximity to a currency indicator in the first scanned invoice; and
determining that a numeric string of the plurality of numeric strings representing a largest amount of currency is the gross amount of the first scanned invoice.

10. The method of claim 7, wherein the determined anchor term is the tax amount and the conducting of the search of the first scanned invoice comprises:
determining a plurality of numeric strings in close proximity to a currency indicator in the first scanned invoice;
determining a first numeric string of the plurality of numeric strings representing a largest amount of currency and a second numeric string of the plurality of numeric strings representing a next-largest amount of currency;
determining a difference between the largest amount of currency and the next-largest amount of currency; and
determining that the difference is the tax amount of the first scanned invoice.

11. The method of claim 7, wherein the determined anchor term is the supplier and the conducting of the search of the first scanned invoice comprises:
determining a plurality of potential suppliers of the first scanned invoice;
determining a name of each of the plurality of potential suppliers included in the first scanned invoice;
determining one of the plurality of potential suppliers having an address identical to an address on the first scanned invoice; and
determining that the determined one of the plurality of potential suppliers is the supplier of the first scanned invoice.

12. The method of claim 7, wherein the determined anchor term is the line item detail and the conducting of the search of the first scanned invoice comprises:
determining that data items on a common line of the first scanned invoice satisfy a relationship defined as (a*b=c); and
determining that data items are the line item detail.

13. A system, comprising:
a database;
a user interface engine to display a user interface to present an initial set of data and to receive an indication of a selection of a sub-set of the initial set of data;
a query engine having access to the database; and
a processor in communication with the query engine, the processor being operative to:
receive a text file representation of an invoice associated with a supplier;
receive, from the database, an invoice term associated with the supplier;
determine whether the invoice term is in the text file representation of the invoice;
determine, in an instance it is determined that the invoice term is in the text file representation of the invoice, an anchor term associated with the invoice term for the supplier associated with the invoice; and
store the invoice term and the anchor term in a record associated with the supplier.

14. The system of claim 13, wherein the determination of whether the invoice term is in the text file representation of the invoice includes comparing the invoice term with the text file.

15. The system of claim 13, wherein the invoice term received from the database is verified as being associated with the supplier before it is stored in the database.

16. The system of claim 13, wherein the text file representation of an invoice for the supplier is produced by scanning the invoice.

17. The system of claim 13, wherein the processor is further operative to:
determine a spatial location of the determined anchor term relative to the associated invoice term; and
store the spatial location of the determined anchor term in the record.

18. The system of claim 13, wherein the processor is further operative to conduct a search of a first scanned invoice from the supplier, where the search is based on the determined anchor term.

19. The system of claim 18, wherein the determined anchor term is at least one of: an invoice date, a gross amount, a tax amount, a supplier, and a line item detail.

20. The system of claim 19, wherein the determined anchor term is the invoice date and the conducting of the search of the first scanned invoice comprises:
determining a plurality of dates included in the first scanned invoice; and
determining a latest one of the plurality of dates which is prior to a current date; and
determining that the latest one of the plurality of dates is an invoice date of the first scanned invoice.

21. The system of claim 19, wherein the determined anchor term is the gross amount and the conducting of the search of the first scanned invoice comprises:
determining a plurality of numeric strings in close proximity to a currency indicator in the first scanned invoice; and
determining that a numeric string of the plurality of numeric strings representing a largest amount of currency is the gross amount of the first scanned invoice.

22. The system of claim 19, wherein the determined anchor term is the tax amount and the conducting of the search of the first scanned invoice comprises:
determining a plurality of numeric strings in close proximity to a currency indicator in the first scanned invoice;
determining a first numeric string of the plurality of numeric strings representing a largest amount of currency and a second numeric string of the plurality of numeric strings representing a next-largest amount of currency;
determining a difference between the largest amount of currency and the next-largest amount of currency; and
determining that the difference is the tax amount of the first scanned invoice.

23. The system of claim 19, wherein the determined anchor term is the supplier and the conducting of the search of the first scanned invoice comprises:
determining a plurality of potential suppliers of the first scanned invoice;
determining a name of each of the plurality of potential suppliers of the first scanned invoice;
determining one on the plurality of potential suppliers having an address identical to an address of the first scanned invoice; and
determining that the determined one of the plurality of potential suppliers is the supplier of the first scanned invoice.

24. The system of claim 19, wherein the determined anchor term is the line item detail and the conducting of the search of the first scanned invoice comprises:
determining that data items on a common line of the first scanned invoice satisfy a relationship defined as (a*b=c); and
determining that data items are the line item detail.
